(19) United States
(12) Patent Application Publication
(10) Pub. No.: US 2022/0224517 A1
(43) Pub. Date: Jul. 14, 2022

(54) Method and apparatus for universal identity (UID) management system based on distributed public certificate service network

(71) Applicant: Yanong Zhu, Santa Cruz, CA (US)

(72) Inventor: Yanong Zhu, Santa Cruz, CA (US)

(21) Appl. No.: 16/923,998

(22) Filed: Jul. 8, 2020

(51) Int. Cl. H04L 9/08; H04L 9/32; H04L 9/40

(52) U.S. Cl. CPC H04L 9/088; H04L 63/0823; H04L 9/3263

(57) ABSTRACT

Method and apparatus for universal identity (UID) management system based on distributed public certificate service network includes: clients, BNET network, certificate servers, and administrators. The BNET is a network that forwards data packets based on the verified UIDs of the packets. The clients, certificate servers, and administrators are connected through the BNET. The certificate servers have two categories: root certificate servers (RCS)s and local certificate servers (LCS)s. A RCS keeps a root key and a root certificate. A RCS issues certificates for the LCSs, and a LCS issues certificates to clients. The root certificates are pre-installed in the clients' Apps. During a client service activation process, a client generates a pair of keys, one private key and one public key. The public key will be used to generate a public certificate request with a common name, in form of C_R_X. A C_R_X is a numerical numbers, character symbols, or a mix of numerical numbers and characters; C represents a country, R represents a region, and X represents the client. The private key is saved in the client's private, protected storage area. Each C_R is associated with a local certificate server (LCS) that is managed by administrators. After a BNET application server received the certificate request from client UID1: C1_R1_X1, the request will be forwarded to the home certificate server (HCS) which is in LCS at UID2: C1_R1_LCS1. For the client UID1, the root certificates and the chain of certificates are bound with the App during the initial activation processes and are verified by publicly published hash. During activation, a certificate administrator at UID2: C1_R1_LCS1 will digitally sign the UID1 certificate with a verification level from the UID1 certificate request if the client UID1 provides necessary and sufficient verification information. The identity verification levels are determined by the administrative rules and the information provided by the client. The signed UID1 certificate will then be sent back to the client UID1. The client UID1 will certify the signed public certificate using the root certificate C1, the certificate chain C1_R1, and the UID1 private key. Once the client UID1 decides to install the new UID1 certificate, an activation message will be sent to the UID2: C1_R1_LCS1, and the UID2 will update the HCS and all other LCS's, which are maintaining information on UID1. The UID management system provides a foundation for DID (Distributed Identity Network).

### FIELD

The following disclosure relates to a universal identity (UID) management system based on the distributed public certificate service network.

### BACKGROUND

In a traditional telephone network, the client is authenticated by a hardware wire that is connected to a central office. In our modern wireless world, clients are authenticated by the digital keys in their SIM cards. On the internet, the most commonly used authentication method is to log in to an account through a representative server using a combination of the client's username and password. This representative server is a “middle man”, such as an email server or website. The private key and public key authentication methods are also used in Internet based PKI servers, that requires professional handlings, and not is designed for general public.

Internet by itself does not have ability to authenticate a client because the only identity on an IP packet is an address, which can be easily faked.

The “middle man” method is designed to overcome the lack of identification on the Internet. An Internet middle man is usually a server or a cloud of servers' farm, which keeps clients' usernames and passwords. A client is identified by the username and password when the client logs in to the server.

For a transaction that requires a middle man, it is not guaranteed that the transaction comes directly from the client. The middle man can make the same transaction without the client's instruction. Using a middle man also does not comply with the law in some countries, as the law requires: “The signer must be the one and only one has the signing key.”

The middle man method is based on the concept of a centralized secret architecture. The middle men keep and verify the usernames and passwords, leading leaks in secrecy by these middle men to be devastating. Information has been leaked many times so far in our market, resulting in several hundreds of billions of dollars in losses.

Every website requires a different username and password for security purposes. However, when a client needs to access multiple websites, remembering many different usernames and passwords becomes extremely inconvenient.

The middle man method limits the capability of information exchanges over the internet to a certain extent. For example, the middle man method puts a limit on the size of the data, the format of data, and the contents of the data. The network of the future should not impose these limitations.

Alongside limiting information, the middle man method also has the potential to reduce the value of the information being exchanged, therefore harming society as a whole. There are many different motives for a middle man to filter, modify, change the credibility of, and/or exaggerate information. The middle man might also be driven to add fake evidence, add advertising, and alter the accuracy of the information. Any of these acts would be extremely troublesome to clients and to society.

In lieu of using a middle man, using private key and public key or public certificate infrastructures to authenticate clients on the internet has many advantages. The most important one is security. Even though the CPU's of our modern computers become more powerful, with key lengths reaching 4096 bits or longer, it is still nearly impossible to breach the security of the aforementioned system, even with a quantum computer. The uniqueness of the private key will prevent fake digital signatures since all signatures must originate from the private key. It will also avoid massive information leaks or security breaches that may have been a side-effect of middle man methods. The private keys are stored in the client's own terminal devices, therefore if there were to be a security leak, it would only be able to take place one device at a time.

The biggest challenge to the public certificate infrastructure comes from the global management of the certificates because different countries and regions may have very different rules and methods regarding identity verifications, as well as having different cultures, time zones, laws, and etc. To guarantee the uniqueness of a private key, both the private key and public certificate request have to be created on a client device. The certificate request has to be signed by certificate administrator with the necessary and sufficient evidence to prove that the request is from the client. Traditionally, one server or one cloud based PKI cannot satisfy the needs of universal identification services.

The certificates require maintenance, and at different countries with different cultures the maintenance practices may vary significantly. Situations that may need to be handled are: lost client devices, leaked private keys, client device resets, expiration dates reached, a change in government regulations or laws, etc. These will be varying from country to country, so thus a distributed certificate service is a much better choice.

A distributed certificate service will limit each certificate administrator's power to issue certificates, geographic area coverage, and other privileges. Therefore, many unwanted management problems can be prevented.

The distributed certificate services may be run by multiple independent organizations, as required by law in some countries.

The distributed certificate services have much better chances of surviving natural disasters, for example, as multiple backbone fibers break down.

When a certificate has a problem, the network operators need to identify the issuers of the certificate, in order to solve the problem on time. When the number of certificate administrators becomes very large and spread out over different countries and regions, an effective management system will be necessary to keep the service running smoothly.

### SUMMARY

A method and apparatus for universal identity (UID) management system based on distributed public certificate service network include: clients, BNET network, certificate servers, and certificate administrators. A client has a client App in his terminal device, which is a cellular phone, a PC, a Mac, a server, or any device with OS. A client App can be downloaded from the network website, App stores, as pre-packaged software, or distributed by local certificate server administrators.

BNET is a network that forwards data based on verified UIDs, and is a DID based network (Distributed Identity Network). Each data packet contains source UID1 and destination UID2. To send a message through BNET, the sender UID1 encrypts the message using a session key and attaches a session ID to the encrypted message. The session key and session ID of UID1 are produced when the client signs on to the BNET access server, and they are generated by BNET access server after the verification of the UID1 identity. When BNET delivers a message to UID2, the message will also encrypted by UID2's session key to guarantee UID2's true identity.

Each client has a unique universal identification number (UID), in the format of C_R_X, where “C” consists of digits or symbols that represent a country, “R” consists of digits or symbols that represent a region, and “X” consists of digits or symbols that represent a client in region R and in country C. Each number C_R_LCS1 represents a local certificate server (LCS) with administrators for client identification management, that C, R are the same as in clients' UID's C_R_X, and LCS1 is the LCS address.

During the activation process, a client will first fill out and submit an application form that contains a telephone number or address from the BNET application server. Then, based on the telephone number or address, the BNET application server will provide a list of UIDs for client to choose. After the client selects a UID from the UID list, the client's App will send a public certificate request with a common name to be selected UID to the BNET application server. The application server will send the client's application material to the home certificate server (HCS/LCS) through BNET, based on the client's UID, where HCS is part of LCS. The administrator of HCS verifies the true identity of the client UID1. After passing the verification process, the HCS administrator will sign the certificate with a verification level that is based on the information provided by the client UID1. The administrator will then send the signed certificate back to the client UID1. The client UID1 will certify the signed public certificate against the certificate chain to verify that it is valid, and against the private key to verify the ownership.

To activate a certificate, the client's App will send a message to his HCS. After the message is verified, HCS will add this certificate to all related local certificate servers (LCS). After a LCS receives a new certificate, it will send a message to all related clients to update the certificate.

For a client with UID1:C1_R1_X1, to add client UID2:C2_R2_X2 to contact list: if C1, R1 are the same as C2 and R2, UID1 will fetch the UID2 from HCS UID3: C1_R1_LCS1 and then install the certificate; If C1, R1 and C2, R2 are different, UID1's LCS at UID3: C1_R1_LCS1 will first check the certificate cache, and if the certificate cache does not have the certificate, UID3 will fetch the certificate from UID2's LCS at UID: C2_R2_LCS.

The client App will keep copies of old public certificate for rollback purposes. To rollback the certificate at LCS, the administrator will have manually to complete the task to avoid attacks.

The certificates for HCS/LCS are issued by upstream servers of the verification chain during installation. The chain of certificates links the verification chain between HCS/LCS to root certificates.

The update of a root certificate must happen through updating the client's App. The root certificate has to be published in such a way that it is publicly well known and cannot be altered easily. An example of this publication might be on block chain servers or through the media. The hash of the root certificate should be in readable format and easily downloaded or copy pasted. A client's installation and update of a chain certificate is through LCS servers. The client App will prompt the user for confirmation of chain certificate installation. The chain of certificate will be verified against the root before installation.

The BNET with application servers, UID, keys and certificates are the foundations of the DID (distributed Identity) system. The system is designed for identifications, transactions, and communication with privacy.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating the relationship between BNET, RCS, LCS, and Clients.

FIG. 2 is a block diagram illustrating the tree relationships between the root/country certificates and services, the regional certificates and services, and clients.

FIG. 3 is a block diagram illustrating that split regional certificates and services into three layers to three layers.

FIG. 4 is a block diagram illustrating the relationship between root or country certificate i, the LCS for country i and region n, and the clients for country i, region n. The dots lines are the logic relationships.

FIG. 5 is a block diagram illustrating the structure of a LCS. It contains HCS, certificate cache server (CCS), chain certificate cache server (CCCS), and administrator management server. A HCS contains a related LCS pointer table. Each CCS and CCCS contains a related client pointer table (RCPT).

FIG. 6 is a table for the structure of related LCS pointer table. Where UID1 is related to three LCSs with UID: UID_LCS1, UID_LCS2, and UID_LCS3. UID2 is related only to UID_LCS2.

FIG. 7 is a table for the structure of related client pointer table. Where UID1 is related to three clients with UID: UID_CLIENT1, UID_CLIENT2, and UID_CLIENT3. UID2 is related only to UID_CLIENT2.

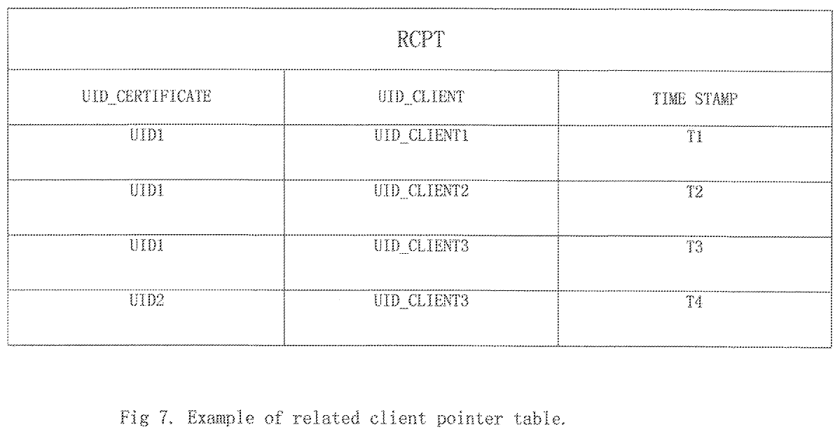

FIG. 8 is a diagram illustrating the process of issuing a new certificate.

FIG. 9 is a diagram illustrating a new certificate installation process.

FIG. 10 is a diagram illustrating a process for client with UID1 to get the certificate of UID2.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

This invention is related to universal identity (UID) management system based on distributed public certificate service network includes: clients, BNET network, certificate servers, and administrators.

A client installs the App with a unique UID number in the client's terminal device, which is a cellular phone, a PC, a Mac, a server, or a device with OS and enough data storage to store a private key, certificates, and with the capability to run the App program. A client's App can be downloaded from the network website, the App stores, as pre-packaged software, or distributed by local certificate server administrators.

The network, BNET, is a network that forwards data based on verified UIDs. A BNET contains access servers (AP), application servers, and backbone networks. An application server is designed for handle clients' applications and activations, and each application server has a unique UID on BNET. An access server is for clients to sign on to BNET network and for the purpose of providing a secure link with clients. An application server is connected to an access server in the same way as a client connected to access server. The backbone is designed to link between access servers and backbone keeps all traffic encrypted. During the sign on process, communication between a client and the BNET access server is based on the encryption of public and private keys. A client sends a message that requests a sign on to a BNET access server, and the message is encrypted using BNET access server's public key. BNET access server decrypts the message by using its private key and responds to a message with the session ID and session key; both ID and key are 32 bytes random bytes. The BNET access server encrypts the response message by using the client's public key. The client's message and BNET response message contain a timestamp, a sequence ID, and a random token for security purposes. Once the client decrypts the message and gets the session ID and session key from BNET, the sign on process is completed. A session ID with session key identifies an UID and therefore a client. Any further communication between the client and BNET on this session will be on this session ID and the session Key. The messages are encrypted and decrypted using the session key. A session ID and a UID is one to one mapped.

During the activation process, a client App will first produce private key and public key pairs. Then, the client will fill up and submit an application form from the BNET application server that contains a telephone number or an address. Based on the telephone number or address, the BNET application server will provide a UID list for the client to choose. After the client selects a UID from the UID list, the client's App will send a public certificate request produced from the client's public key with a common name to be selected UID to BNET application server. The connection between Client and Application server during application/activation is based on SSL. The application server will then forward the client's application material to the home certificate server (HCS/LCS) through BNET, where HCS is part of LCS. The administrator of the HCS will verify the identity of the client UID1. After passing the verification process, the HCS administrator will sign the certificate with a verification level based on the information provided by the client UID1 and send the signed certificate back to the client UID1. The client UID1 will certify the signed public certificate against root certificate and certificate chain to verify it is valid, and against the private key to verify the ownership.

Every component on BNET that requires communication with others has a unique, verified UID and keeps its private keys private and capable of sending and receiving messages via BNET.

In order to have BNET services, a client must have his private key and a certificate. The certificate must be officially issued by his local administrator. A local administrator is an administrator that geographically administrates all clients in a geographic area.

If a message from UID1 to UID2 requires an additional level of encryption, UID1 will use UID2's public key from UID2's public certificate to accomplish the task. In the case that UID1 does not have certificate of UID2, App will automatically downloads the certificate of UID2. An automatic verification process will take place when UID2 certificate is downloaded. The UID2 certificate is verified by using its root certificate and chain of certificates.

A BNET access server keeps all root certificates, all chain of certificates, and all revoke list of certificates for the whole world; it is capable of verifying the client certificates for both home and visiting clients and allowing them to access the BNET. A BNET access server stores local certificates for clients and maintains a cache of certificate for visiting clients. A BNET access server also makes requests to download certificate for a client from remote LCSs if it cannot find certificate for this client.

A local certificate server (LCS) is a part of a distributed certificate service network. It is a client of BNET with an UID. It keeps all required certificates for both local and visiting clients; including root certificates, the chain of certificates, and the revoke lists.

An administrator uses a home location certificate server (HCS) in LCS to serve to local clients. In addition, an administrator may also have a signing key and a certificate for issuing client certificates. FIG. 11 shows the diagram of the relationship for clients, APs, LCS, administrators, and Backbone of BNET. It also shows how the certificates and keys are stored in each part of the network.

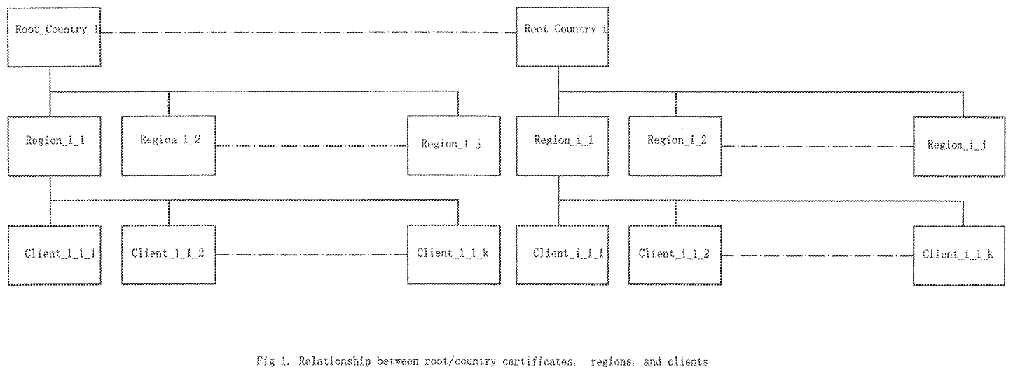

FIG. 1 shows the relationship between Clients, local certificate servers (LCS), root certificate server (RCS) and BNET. Each Client will be assigned to a LCS based on their C_R in his UID that this LCS is also called the home certificate server (HCS) for this client. The same client may also use a different LCS which is not based on C_R in UID. In this case, the LCS is called a visiting certificate server (VCS). The differences are that the administrators at HCS maintain the client's identity verification information while the VCS does not; other LCS's get the client's certificate from his HCS, not from his VCS.

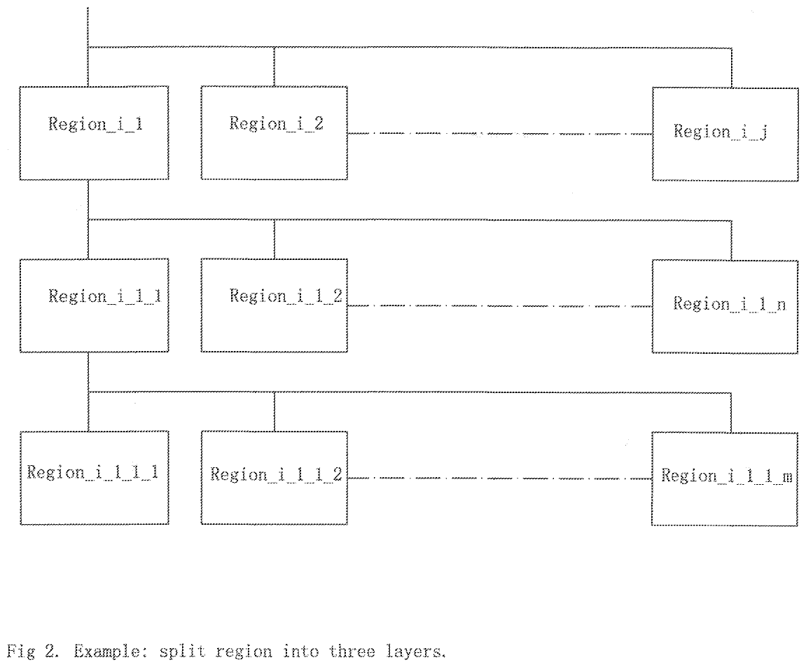

FIG. 2 is a block diagram illustrating the tree relationships between the root/country certificates and services, the regional certificates and services, and clients. Each country has at the least one set of root keys, a public certificate, and a server with UID: C, the country symbol. An administrator with root keys and a certificate can issue regional certificates and a chain of certificates with UID: C_R, the country and region symbols. A regional administrator with keys and a certificate can issue a client certificate with UID: C_R_X.

A root or country certificate server with administrators is based on root keys and a certificate. The root certificates are embedded in the client's App. The hash of the root certificate is published on well known public servers, such as on a block chain and printed on published papers.

A local certificate server (LCS) with administrators is based on regional keys and a regional certificate. A regional certificate is issued by a root certificate administrator. A regional certificate can be verified by using a root certificate.

Each client has a unique UID that is embedded in the client's public certificate; the client's certificate can be verified through a root certificate and certificate chain. The identity management system is also the management system of public certificates.

A universal identification number (UID) has a structure C_R_X. A “C” represents a country, an “R” represents a region, and an “X” represents a client. C, R, X can have different lengths and different data types. A typical configuration is that C is 4 digits, R is 6 digits, and X is 6 digits—a total of 16 digits per UID. Each UID represents a client, a server, or one other type of device with OS. A UID is not limited to be a digit; a UID can also be made of characters or a mix of digits and characters. The length of the UID is also not limited to 16 digits. With modern CPU speed, the “longest match first” method can easily solve the variable length problem.

The C, R, X in a UID can be characters: “C” can be a brief name of a country, “R” can be a brief name of a region or a city, an “X” can be a brief name of a person or an organization.

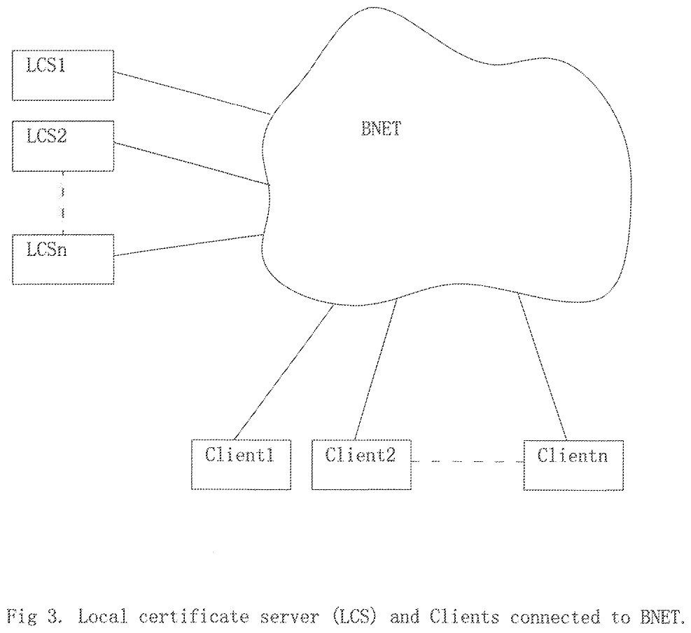

There are situations where a regional certificate should be split into multiple levels to reduce the regional local certificate server coverage area. FIG. 3 is a block diagram illustrating that split regional certificates and services into three layers.

To enable a higher identity verification level, the client must verify his identity with his home certificate server (HCS) administrator by sending identity verification materials.

An alternative way to increase verification level: a client can collect a set of digital bindings between his UID and the NAME he gives other clients for his identity. For example, a client can be digitally signed by a college state “NAME:XXX UID:YYY DATE:zzz MSG:has Ph.D in computer science from MIT Year 2010”; or from the DMV “NAME:XXX UID:YYY DATE:zzz MSG:over 21.”; and etc. By this method, the client's identity will be provided by multiple organizations. These collected digitally signed documents can be self published in order to increase the identity levels, or sent to LCS with a certificate request to upgrade the certificate their verification level.

A HCS administrator operates a HCS through the administrator management server on local certificate server (LCS), or multiple administrators operate one HCS via their own terminals, each with a separated UID.

For a HSC administrator to verify the identity or increase the identity level of a client, the client will have to provide sufficient evidence for their identity verification. This evidence varies depending on the law of the country. For example, for some country, any of one of the following, or mix of the following, will be sufficient evidence: online video interview, walking into an office in person, a telephone text message activation code, a bank card payment, an existing trustable internet account, recommendations by higher identity levels, etc.

Once the evidence from a client meets a verification level, a certificate request will be approved for this level. The HCS administrator will digitally sign the request and make it to be a verifiable public certificate. The identity level will be embedded in the certificate. The public certificate now can be verified via a chain of certificates and the identity level can be seen on the certificate as well. The certificate will be sent back to the client for further processing.

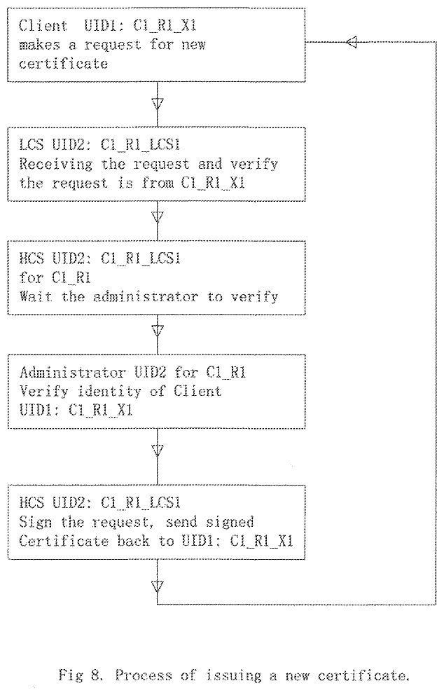

FIG. 8 shows the process in which a client with UID1: C1_R1_X1 sends a request for a new certificate to LCS at UID2: C1_R1_LCS1, then to HCS at the same UID2. An administrator signs the certificate request after the verification is completed. Then, the administrator will send a new UID1 certificate back the client. To maximize the security of the signing key, the administrator signing the certificates process can work in offline batch mode to keep the signing key offline at all times.

After the client receives the approved certificate from his HSC administrator, his App will verify the certificate through the chain of certificates and through his private key. After all verifications are successful, the client is ready to install the certificate on BNET. To install the new certificate on BNET, the client has to make an installation request that will send a new certificate serial number to HSC with the client's installation order with a digital signature.

After the HCS receives the client's certificate installation request, the HCS will verify the request qualifications. If the request passes the qualifications, then the certificate will be first installed at HSC with a specific effective time, and then, an update message will be sent to all related caches of other ICS's. After a LCS receives the update message, the LCS will also check the related client cache pointer table (RCPT) for clients then send an update message to the listed clients.

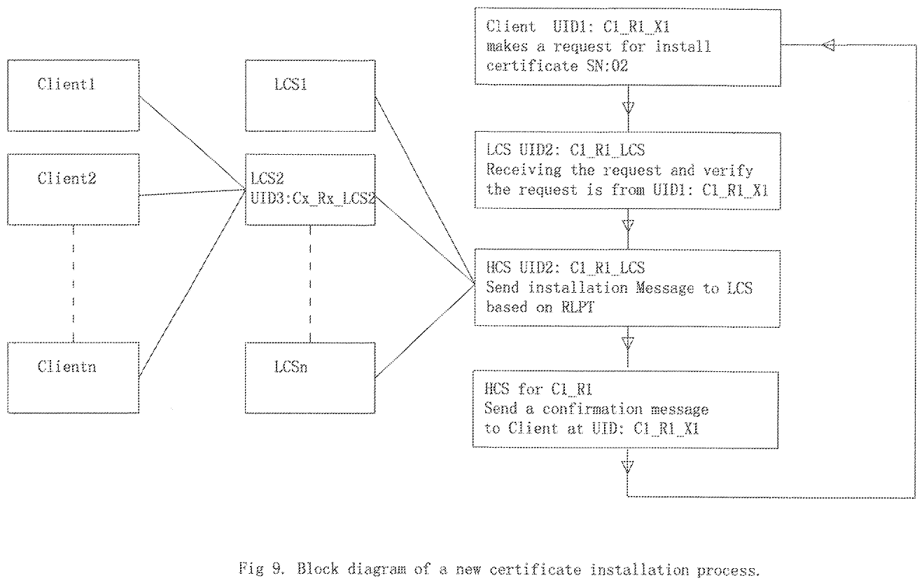

FIG. 9 shows the process of installing a new certificate. The Client at UID1: C1_R1_X1 makes a request for an installation certificate with the serial number SN: 02. The LCS at UID2: C1_R1_LCS receives the request, verifies the request is from UID1, and then sends the request to HCS at UID2. The HCS will update the certificate for UID1 and send an update message to other LCS's based on the related LCS pointer table. Once a LCS at UID3: Cx_Rx_LCS3 receives the certificate update message, it will update the cache servers and check the RCPT for updates on all online clients for UID1. A client App will automatically check for update messages when it is signed on to a network, just in case it misses the update message while offline.

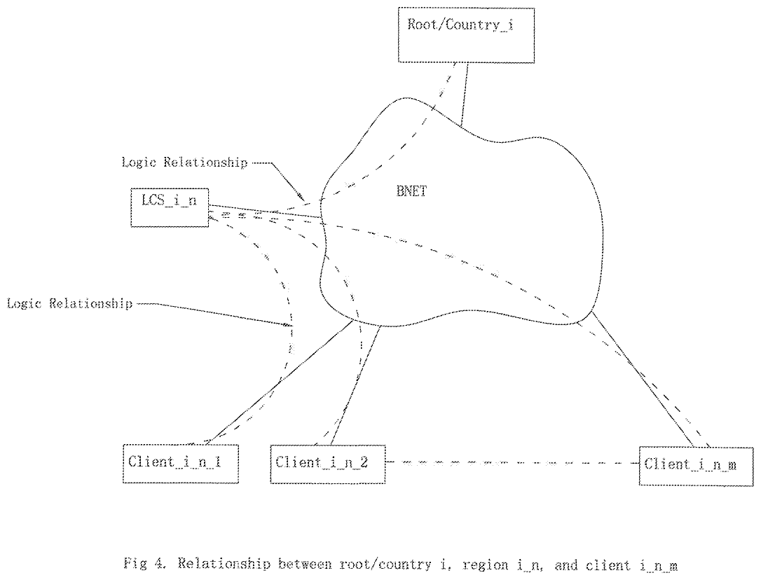

The verification of a certificate happens through verification chain certificate logic. The root certificates are distributed along the client's App. A tool distributed along with Client's App can produce a digital hash of the root certificate. This root hash can be verified with published root hash in public news media. Every time a contact UID2:C2_R2_X2 certificate is added to the client's App, the App will also check the related chain certificates for C2_R2. If the chain of the certificate C2_R2 is not found, the App will automatically download the chain of the certificate C2_R2 from LCS or from HCS at C2_R2_LCS2. The App will verify the chain of the certificate C2_R2 against the pre-installed root certificates C2. After verifying the chain of certificate C2_R2, the App will also verify the client's certificate C2_R2_X2 against the chain of certificates C2_R2. The structure of UID: C_R_X will allow the verification process to be more efficient with matching the certificates because of the chain that root C2 issues regional C2_R2 and regional C2_R2 issues client C2_R2_X2. The relationship between root, regional, and client certificates are shown in FIG. 4.

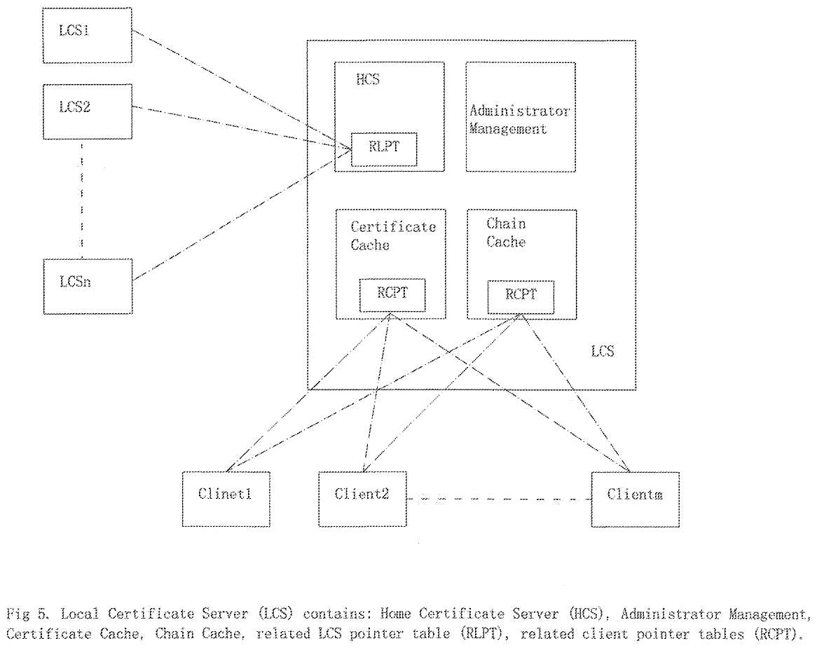

A local certificate server (LCS) contains following the modules: one HCS for local clients, one certificate cache server (CCS) for local clients using remote certificates, one chain certificate cache server (CCCS) for the local clients using the remote chain of certificates, and an administrator management server to enable the administrators to operate the LCS. A HCS contains a related LCS pointer table (RLPT). A RLPT keeps the record for other LCS's that are using a UID with time stamps. Each CCS and CCCS have a related client pointer table (RCPT) that keeps the record for each remote UID that local clients are using. FIG. 5 shows the relationship between LCS, HCS, CCS, CCCS, RLPT, TCPT, LCS, and Clients.

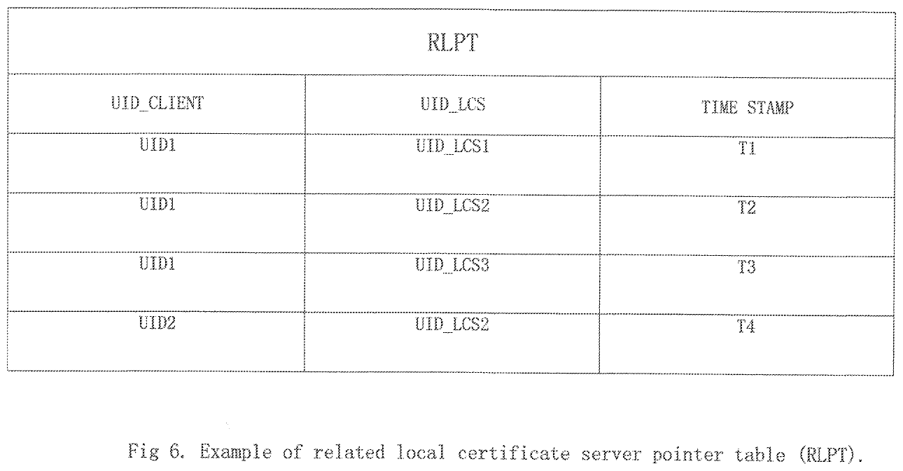

The RLPT is a related LCS pointer table in HCS. It points to the LCS's that are using the certificates issued by this HCS's administrator. FIG. 6 is a table showing an example of the relationship between a local UID and the UIDs of remote LCS. The UID1 is a local UID, it has been used by LCS1 at UID_LCS1, UID_LCS2, and UID_LCS3. The UID2 is a local UID, it has been used by LCS2 at UID_LCS2.

The RCPT is a related client pointer table in CCS and CCCS; it keeps track of certificates or a chain of certificates for updates.

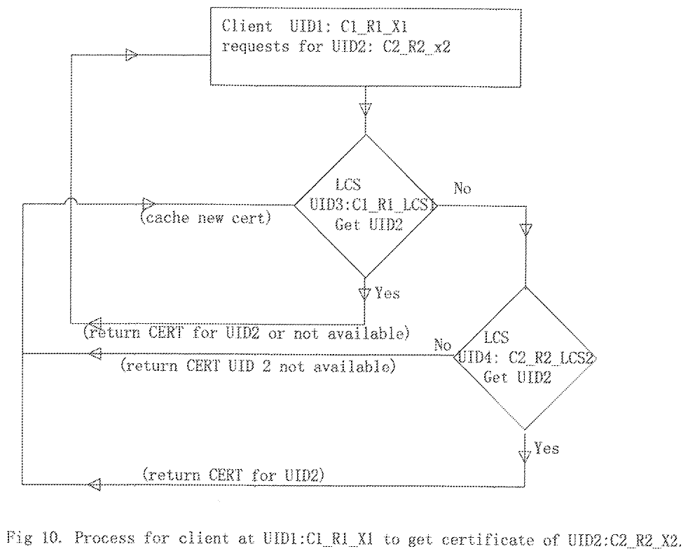

FIG. 10 shows the process of how a client at UID1: C1_R1_X1 will get a certificate of UID2: C2_R2_X2 from LCS at UID3: C1_R1_LCS1. If the LCS at UID3 does not have certificate of UID2, the LCS at UID3 will send the request UID4: C2_R2_LCS2 that is the HCS of UID2. If a certificate UID2 is found in UID4, the certificate UID2 will be returned to UID3, then returned to UID1. The UID3 LCS will cache the certificate UID2 and update the related client pointer table. The UID4 will also update the related LCS pointer table for UID2.

When a HCS1 at UID1 gets a request for certificate UID2 from a LCS3 at UID3, the HCS1 will add UID3 to RLPT, and the requested certificate UID2 will also add to the certificate cache of LCS3 at UID3.

A cache record has an expiration time. At the expiration time, the record will be removed. The expiration time is a configurable parameter by the system administrator. The expiration times are consistent at different levels related to the pointer table and cache levels. A contact certificate in a client's App will not be automatically removed.

During an installation, once all related caches at the LCS level have completed the update, the HCS will send a confirmation message to the client along with the time at which that certificate will become effective. Before the effective time, the old certificate will still be used for keeping the communication channel open. The client has to respond to the confirmation before the new certificate become effective. After the effective time, the client will send a message to HCS to indicate that the update was successful, and HCS will return a message to the client that indicates the end of update. If this does not occur, after a waiting time which is configurable by network operator, both BNET and the client will roll back to the old certificate.

When a client UID1 adds a new contact UID2, UID1 will send a get certificate request for UID2 to UID1's HCS. If the UID1's HCS does not have UID2's certificate, the HCS will contact UID2's HCS to get the certificate.

A certificate contains a common name, a nickname, a real name, issuer information, serial number, identity level, and an expiration date. A BNET application can hide the identity of its client only if an application provides a one to one mapping between UID and the application's client ID. A business organization should always provide their real identity to their clients.

A certificate UID1: C1_R1_X1 can be revoked by an administrator or by its owner through HCS in LCS at UID2: C1_R1_LCS1. The LCS at UID2 sends a message, along with serial number of the certificate of UID1, and the time at which it was revoked to all related LCS by loop over RLPT. Once a LCS receives a message that indicates a certificate should be revoked from the certificate's HCS, the LCS will send messages to all related clients by loop over RCPT to revoke this certificate. For a offline client, the revoke message will send to the client when the client is online again. Once a certificate is revoked, the status of the certificate will be marked as revoked. If a new certificate with the same UID as the revoked certificates is installed to a client, the revoked certificate will be replaced by the new one.

A chain of revoking certificates has to be done by higher level of issuer. For example, the revoke message of a chain has to be signed by root private key owner for the LCS's, and by the clients, in order to accept the message.

A root certificate can only be revoked by updating the client's App.

A BNET client App can digitally sign a document with the private key and verify a digital signature by using the signer's public certificate.

An application that requires a digital signature and verification can use a BNET client App, contact list, or LCS to access keys and certificates. When a client signs data, for example an electronic check, a message, a note, a post, or a contract by using his private key, then, the client sends the signed data to others along with the digital signature.

It is convenient to package the signed data, the signature, and the signer UID in a single file. A good practice is to put them in a zip file with format: uidxxx.txt, datayyy.dat, datayyy.sign512. During the verification, the App can automatically collect UID, FILE, and FILE signature files to verify the signature. The App will search for certificates related to the UID locally, if it is not found, it will search from the UID's LCS in order to download and verify it.

Data (message or file) can be signed by multiple parties. When data is signed by multiple parties, the signed data object will contain data and multiple signatures, and each signature will contain a UID identifier. An electronic check, a contract, or other important messages may require multiple signatures for better management purposes.

The internet middle man architecture is a central secrecy system. It keeps all clients' username and password in servers' central database. In the case of security leak, the damage will be permanent. It is very difficult to ask all clients to replace their password. BNET solves this issue by allowing clients to use their distributed identity to login and no secret is giving in during the login process. When a client UID1 needs to login website UID2, the client browser browses the website through https, and the web server will generate a html login page with website UID2, a temporary token and a java script. The java script sends the token and website UID2 to client's App. The token is 32 characters long random character string and also stored in the UID2's login control database. The UID1's App will produce a message that is made of the token, UID, time, and signature of the message from UID1; this message will be sent to UID2 through BNET. The website client App at UID2 will verify this message and message's digital signature from UID1 and token time stamps. If the message is verified, UID2 will generate a password and store it under the username UID1 in the login data base. UID2 sends a message to the client at UID1, and the message contains the password. The client UID1 now has both the username:UID1 and temporary password:password_from_UID2. This enables the client to log in to the website at UID2 automatically.

Login a website without registration, username and password can provide clients significant improvement of convenience, especially for smaller websites, or occasionally used website.

There are many different methods of secure communication between two clients UID1 and UID2 of BNET. The simplest way is to use each others' public key to encrypt data and then use a private key to decrypt the data. This method requires intensive CPU power when there is a large amount of data. The second way is to use a shared session key to reduce CPU power demands. The sender UID1 generates a temporary session key with a minimum of 32 bytes in length, and uses the UID2 public key to encrypt the session key and send it to UID2. UID2 uses its private key to decrypt the session key. Then, UID1 uses the session key to encrypt the data, and UID2 uses the session key to decrypt the data.

What is claimed is:

1. Method and apparatus for universal identity (UID) management system based on distributed public certificate services network comprising: clients, BNET network, root certificate servers (RCS)s, local certificate servers (LCS)s, and certificate administrators. The BNET is a network forwarding messages based on verified UIDs. A UID has the structured format of “C_R_X”. A “C” represents a country, an “R” represents a region (a province or a state), and a “X” represents a client. Each LCS has a unique UID: C_R_LCS. A LCS with UID: C1_R1_LCS1 provides certificate services for all clients with UID: C1_R1_X given the clients' C1 and R1 are the same as the LCS. A message from UID1 that is forwarded by BNET contains the session ID of UID1, the receiver's UID2, and is encrypted by a session key of UID1. The session ID1 and session key are bound with the identity of UID1, and provide the identity of UID1 for BNET access servers.

2. The method and apparatus of claim 1, wherein the BNET network is a network that forwards messages based on source and destination verified UIDs. A session ID and a session key pair provide a secure connection between the client and BNET. The session ID and session key are produced during the client sign in process by using a digital signature and certificate of both the BNET access server and the client. A session ID enables BNET access server to access Identity information, including the session key. Using the session key to decrypt the message will provide verification of the identity. For end to end encryption, UID1 sends message to UID2 by using UID2's public key to encrypt the message body.

3. The method and apparatus of claim 1, using BNET distribute identity to login any website without preregistration or using username and password.

4. The method and apparatus of claim 1, using BNET distribute identity to sign and to verify transactions, to sign and to verify contracts, to sign and to verify identifications, to sign and to verify remote controls commands, and for situations that require to sign and to verify messages.

5. Method and apparatus for universal identity (UID) management system based on distributed public certificate service network comprising: clients, BNET network, root certificate server (RCS), local certificate servers (LCS), and certificate administrators. A client selected UID1: C1_R1_X1 during the activation process and activated with low identity level. A low identity level is indicated in the client's certificate and verified through an email confirmation, telephone message confirmation, or postal mail confirmation.

6. The method and apparatus of claim 3, To reach a higher identity level, the client creates a new public certificate request along with application material for the same UID1: C1_R1_X1. The public certificate request and application material will be sent to HCS in LCS at UID2:C1_R1_LCS1, where an administrator will verify the client's new identity level, sign the request, produce a new public certificate, and send the certificate back to the client. The UID of new certificate will remain the same as old certificate and new identity level will be indicated in certificate.

7. The method and apparatus of claim 3, wherein an administrator is able to verify the identity of a client through additional methods: credit card transactions, live video interview, walk in interview, third party references, or any other credential method for identification.

8. The method and apparatus of claim 3, wherein a client uses accumulated third party digital signed references to increase identity level.

9. Method and apparatus for universal identity (UID) management system based on distributed public certificate service network comprising: clients, BNET network, root certificate server (RCS), local certificate servers (LCS), and certificate administrators. The certificate chains that link the root certificates to all of the LCS are stored in chain certificate cache server in LCS. A LCS has a related chain point table that records the link between each chain and the lower level of LCS or clients who are using the chain. A LCS also keeps tables between each local certificate and its users.

10. The method and apparatus of claim 9, wherein certificate C1_R1_X1 verification is based on the certificate chain of C1_R1. If the chain C1_R1 has not been installed, the client's App will be automatically downloaded as the chain C1_R1 from LCS in order to be verified and installed.

11. The method and apparatus of claim 9, wherein updating a certificate in a chain will result in all lower level certificates to be updated. An update request message has to be signed by a higher level certificate administrator, the message will send to all related LCS and from each LCS to all related clients.

12. The method and apparatus of claim 9, wherein updating a certificate through issuer LCS will result a updating message send to all users who are using this certificate for updating, include renew and revoke. The revoke message will also update revoke list in all LCS.
